(19) United States
(12) Patent Application Publication
(10) Pub. No.: US 2004/0195931 A1
(43) Pub. Date: Oct. 7, 2004

(54) High-efficiency rotating unit using magnetic force

(76) Inventor: Shuichi Sakoda, Kyoto (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/451,788

(22) PCT Filed: Jan. 15, 2003
(86) PCT No.: PCT/JP03/00295

(30) Foreign Application Priority Data
Jan. 19, 2002 (JP) 2002-215875

(51) Int. Cl. H02K 1/22

(52) U.S. Cl. 310/268

(57) ABSTRACT

There is provided a rotating apparatus with high efficiency by means of magnetic force, which comprises a stator ST in which a plurality of electromagnets 2 composed by winding a coil 1 around a core 10 formed of a strong magnetic material are uniformly arranged at the same intervals, the stator ST having a driving shaft hole 9 at the center in which a driving shaft 6 is freely rotatable and the stator ST being provided such that the driving shaft 6 is inserted in the driving shaft hole 9, and rotors RO in which the same numbers of permanent amagnets 3 as that of the electromagnets 2 of the stator ST are arranged at the same intervals as that of the electromagnets 2 of the stator ST on both right and left end surfaces of the stator ST, the rotors RO being fixed to the driving shaft 6 with a small gap 12 with the electromagnet surface of the stator ST. Thus, according to the rotating apparatus of the present invention, the whole surfaces of the permanent magnets of the two rotors provided on both right and left sides of the stator ST with the small gap react to the electromagnetic force generated from the whole surfaces of the both right and left end surfaces of the stator, and the electromagnetism of N→S and S←N is generated from the right and left sides of the stator and the rotation force is aggressively applied to the permanent magnets of the rotor, whereby the strong driving force is provided.

### TECHNICAL FIELD

The present invention relates to a rotating apparatus with high efficiency by means of magnetic force, and more particularly, to a rotating apparatus with high efficiency by means of magnetic force in which electromagnetic force generated from both end surfaces of the electromagnet is effectively used and absorption and repulsion of a permanent magnet are used to generate strong rotational movement, while a conventional motor uses magnetism on only one surface of a stator and its other surface, that is, an outer surface is not used.

### BACKGROUND ART

According to any kind of the conventional motor, a stator composed of permanent magnets or electromagnets forms a certain magnetic field and a rotor reacts to the field to generate rotational movement. For example, as shown in FIG. 18, a rotor 17 of the conventional motor receives only the magnetism generated from one surface of a stator 18 and rotates. In addition, according to the conventional motor, connection and disconnection operations were performed by activating the commutator and the brush and inputting an electric power from one direction only.

The present invention considers the fact that the conventional motor uses only the magnetism from one surface of the stator 18 and its other surface, that is, the outer surface is not necessary and considerably improves this fact to provide a rotating apparatus with high efficiency by means of magnetic force in which the whole surfaces of the magnets of the rotor adjacently provided act to the magnetism generated from both end surfaces of the stator to generate strong rotation force. Furthermore, according to the rotating apparatus of the present invention, while the commutator and the brush input a power from only one direction to perform connection and disconnection in the conventional motor, the power can be input alternately from both right and left sides.

More specifically, according to the present invention, there is provided the rotating apparatus with high efficiency by means of magnetic force, which comprises a stator in which a plurality of electromagnets composed by winding a coil around a core formed of a strong magnetic material are arranged at the same intervals and fixed, the stator having a driving shaft hole at the center in which a driving shaft is freely rotatable, and rotors in which the same number of permanent magnets as that of the electromagnets of the stator are arranged at the same intervals as that of the electromagnets of the stator on both right and left end surfaces of the stator and fixed to the driving shaft with a small gap with the electromagnet surface of the stator. Furthermore, there is provided the rotating apparatus with high efficiency by means of magnetic force in which electromagnetism of N→S is generated from one commutator in the stator formed by winding the coil and then electromagnetism of S←N is generated from the other commutator in the same stator at the next moment.

### DISCLOSURE OF THE INVENTION

According to the present invention, there is provided the rotating apparatus with high efficiency by means of magnetic force, which comprises a stator in which a plurality of electromagnets composed by winding a coil around a core formed of a strong magnetic material are arranged at the same intervals and fixed, the stator having a driving shaft hole at the center in which a driving shaft is freely rotatable, and rotors in which the same number of permanent magnets as that of the electromagnets of the stator are arranged at the same intervals as that of the electromagnets of the stator on both right and left end surfaces of the stator and fixed to the driving shaft with a small gap with the electromagnet surfaces of the stator.

Since the same number of permanent magnets as that of the electromagnets of the stator are arranged at the same intervals as that of the electromagnets of the stator on both right and left end surfaces of the stator constituted as described above and fixed to the driving shaft with the small gap between the permanent magnet surface and the electromagnet surface of the stator, an electric power input from a power supply becomes an electromagnet by passing through the stator in which the coil is wound around the core and the permanent magnet disposed as the rotor reacts when the magnetism is generated on its both ends, whereby rotational movement is unidirectionally generated by the commutator and the brush provided on the driving shaft.

### BRIEF DESCRIPTION OF THE DRAWINGS

FIG. 1 is an exploded explanatory view showing a rotating apparatus according to the present invention;

FIG. 2 is an explanatory view for assembling the rotating apparatus according to the present invention;

FIG. 3 is a sketch of electromagnets constituting a stator;

FIG. 4 is a wiring diagram;

FIG. 5 is an explanatory view showing a state in which two rotating apparatuses according to the present invention are provided in a column;

FIG. 6 is a wiring diagram of FIG. 5;

FIG. 7 is an explanatory view I in which an electric generator is provided adjacent to a power machine comprising the rotating apparatus according to the present invention;

FIG. 8 is a wiring diagram of FIG. 7;

FIG. 9 is an explanatory view showing a state in which the rotor on the right side in FIG. 7 is replaced with a U-shaped permanent magnet shown in FIG. 11;

FIG. 10 is a wiring diagram thereof;

FIG. 11 is an explanatory view showing the U-shaped permanent magnet;

FIG. 12 is an explanatory view showing a stick permanent magnet;

FIG. 13 is an explanatory view II in which the electric generator is provided adjacent to the power machine comprising the rotating apparatus according to the present invention;

FIG. 14 is an explanatory view showing a state in which the electric generator is separated form the power machine;

FIG. 15 is an explanatory view showing a state in which a function of the electric generator is stopped;

FIG. 16 is an explanatory view showing a power input from a commutator and a brush to a stator;

FIG. 17 is an explanatory view showing a state in which a current and a magnetic pole at starting of the stator and the rotor; and

FIG. 18 is an explanatory view showing an example of a conventional motor.

### BEST MODE FOR CARRYING OUT THE INVENTION

According to the present invention as set forth in claim 1, there is provided a rotating apparatus with high efficiency by means of magnetic force, which comprises a stator ST in which a plurality of electromagnets 2 composed by winding a coil 1 around a core 10 formed of a strong magnetic material are uniformly arranged at the same intervals, the stator ST having a driving shaft hole 9 at the center in which a driving shaft 6 is freely rotatable and the stator ST being provided such that the driving shaft 6 is inserted in the driving shaft hole 9, and rotors RO in which the same number of permanent magnets 3 as that of the electromagnets 2 of the stator ST are arranged at the same intervals as that of the electromagnets 2 of the stator ST on both right and left end surfaces of the stator ST, the rotors RO being fixed to the driving shaft 6 with a small gap 12 with the electromagnet surface of the stator ST.

According to the present invention as set forth in claim 2, there is provided a rotating apparatus with high efficiency by means of electromagnetic force according to claim 1, in which the strong magnetic material is formed of a silicon steel plate or permalloy.

According to the present invention as set forth in claim 3, there is provided a rotating apparatus with high efficiency by means of magnetic force, in which a plurality of apparatuses according to claim 1 are adjacently arranged along the driving shaft 6 in a column.

According to the present invention as set forth in claim 4, there is provided a rotating apparatus with high efficiency by means of magnetic force according to claim 1, in which an electric power can be input alternately from the right and left sides of the stator ST through a plurality of commutator and brush circuits 11.

According to the present invention as set forth in claim 5, there is provided a rotating apparatus with high efficiency by means of magnetic force according to claim 1, in which in the rotor RO, a U-shaped permanent magnet 13 or a stick permanent magnet 14 to which a metal plate 15 selected from iron, cobalt, nickel is attached to one end surface is used.

According to the present invention as set forth in claim 6, there is provided a rotating apparatus with high efficiency by means of magnetic force, in which an electric generator GE constituted by the same manner as in a power machine PU comprising the apparatus according to claim 1 and formed of an electric circuit opposite to the power machine PU is adjacently provided at one end of the driving shaft 6.

According to the present invention as set forth in claim 7, there is provided a rotating apparatus with high efficiency by means of magnetic force, in which in the apparatus according to claim 6, a U-shaped permanent magnet 13 or a stick permanent magnet 14 to which a metal plate 15 selected from iron, cobalt, nickel is attached to one end surface is used in the rotor 22 of the electric generator GE.

According to the present invention as set forth in claim 8, there is provided a rotating apparatus with high efficiency by means of magnetic force, in which in the apparatus according to claim 6, the stator 21 of the electric generator GE and the rotor 22 of the electric generator GE laterally move along the driving shaft 6 to expand a gap 12 with the power machine PU and also expand the gap 12 between the stator 21 of the electric generator GE and the rotor 22 of the electric generator GE.

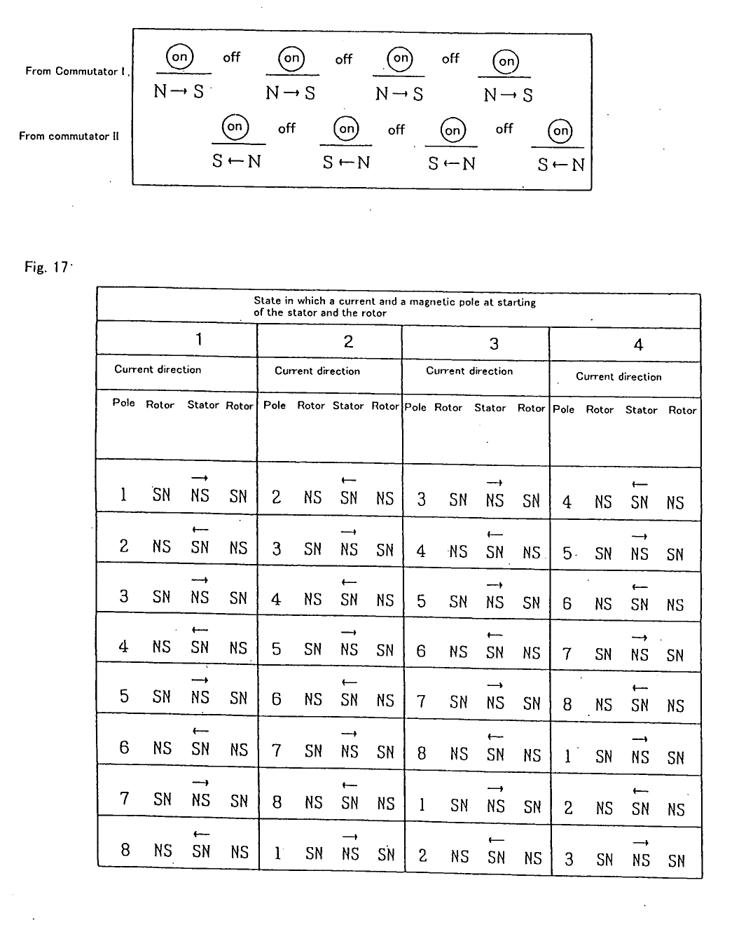

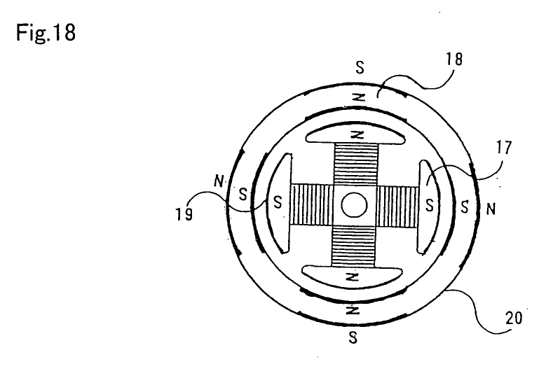

The most important characteristic of the present invention is that electromagnetism of N→S is generated from the left direction of alternate half of the electromagnets 2 of the stator ST composed of the plurality of electromagnets 2 formed by winding the coil, by one commutator and brush circuit 11, and at the same time, electromagnetism is generated from the right direction of the remaining half of the electromagnets 2 (referring to FIG. 16). For example, as shown in the drawing, in a case where eight electromagnets 2 of the stator ST are provided, if they are numbered by No.1 to No.8, the electromagnetism of N→S is generated in No.1, 3, 5, and 7 from the left side by one commutator and at the same time, the electromagnetism of N→S is generated in the No.2, 4, 6 and 8 from the right side (referring to FIG. 17). In other words, an electric power is input to all of the electromagnets 2 of the stator ST at the same time and all of them generate the electromagnetism to aggressively apply absorption and repulsion to the permanent magnet surface of the adjacent rotor RO.

Although the core 10 of the stator ST according to the present invention may be formed of a strong magnetic material, silicon steel plate, permalloy, ferrite or the like is preferable and especially, the silicon steel plate and permalloy are preferable.

Since in the above operation, the core 10 of the stator ST is formed of the above material so that previously input electromagnetism is demagnetized in a moment and there is almost no magnetic flux in the core, the above switching is possible and all of the multipolar stators act on N→S and S←N to be able to generate strong rotational driving force.

Although the conventional motor inputs an electric power from only one direction by commutator and brush to perform connection and disconnection operations, in this case, the adjacent stator is in a disconnected and halted state at the moment one stator acts on N→S, that is, half magnetic force is halted even if it is multipolar.

Thus, according to the rotating apparatus of the present invention, the whole surfaces of the permanent magnets of the two rotors RO provided on both right and left sides of the stator ST with the small gap react to the electromagnetic force generated from the whole surfaces of the right and left of the stator ST, and the strong driving force is provided by generating the electromagnetism of N→S and S←N from the right and left sides of the stator ST and aggressively applying the rotation force to the permanent magnets of the rotor RO. Furthermore, the gap between the electromagnet surface of the stator ST and the permanent magnet surface of the rotor RO can be subtly adjusted.

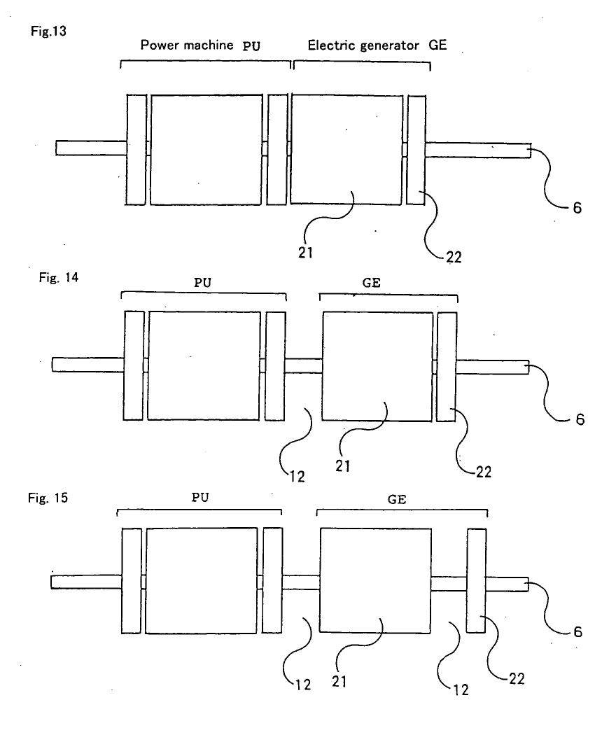

In addition, in the case where the power machine PU comprising the rotating apparatus according to the present invention and the electric generator GE composed of the electric circuit opposite to that of the power machine PU are adjacently provided at one end of the driving shaft 6 according to the present invention, the stator 21 of the electric generator GE and the rotor 22 of the electric generator GE laterally move along the driving shaft 6 to expand the gap with the power machine PU and also expand the gap between the electromagnet surface of the stator 21 of the electric generator GE and the permanent magnet surface of the rotor 22 near the stator 21 (referring to FIGS. 13 to 16). Hereinafter, the present invention will be described in detail with reference to the drawings.

In addition, although an electromagnet 2 of a stator ST is formed of a multilayer silicon steel plate or the like, if the multilayer state is shown in the drawing, it is necessary to enter fine lines therein. Since it is difficult to distinguish the fine lines from lines of a coil and the drawing becomes unclear in this case, the multilayer state of the silicon steel plate or the like is not shown in the drawing and it is shown as a simple solid. In addition, although as power supplies in a wiring diagram in the drawing, in addition to + and −, +′ and −′ are also shown, +and − are provided one by one in practice. In addition, N and S shown in the drawing mean an N surface and S surface, respectively.

Furthermore, in the drawing, reference numeral 1 designates a coil, reference numeral 2 designates an electromagnet, reference numeral 3 designates a permanent magnet, reference numeral 4 designates a commutator, reference numeral 5 designates a magnet cutoff divider, reference numeral 6 designates a driving shaft, reference numeral 7 designates a brush, reference numeral 8 designates a bearing, reference numeral 9 designates a driving shaft hole, reference numeral 10 designates a core, reference numeral 11 designates a commutator and brush circuit, reference numeral 12 designates a gap, reference numeral 13 designates a U-shaped permanent magnet, reference numeral 14 designates a stick permanent magnet, reference numeral 15 designates a metal plate selected from iron, cobalt, nickel, reference numeral 16 designates a power supply, reference numeral 17 designates a rotor of a conventional motor, reference numeral 18 designates a stator of the conventional motor, reference numeral 19 designates a part where the rotor reacts to the magnetism of the stator in the conventional motor, reference numeral 20 designates a part where the stator does not react to the magnetism of the rotor in the conventional motor, reference numeral 21 designates a stator of an electric generator, reference numeral 22 designates a rotor of the electric generator, reference numeral 23 designates a frame body. In addition, reference character ST designates a stator, reference character RO designates a rotor, reference character PU designates a power machine, and reference character GE designates an electric generator.

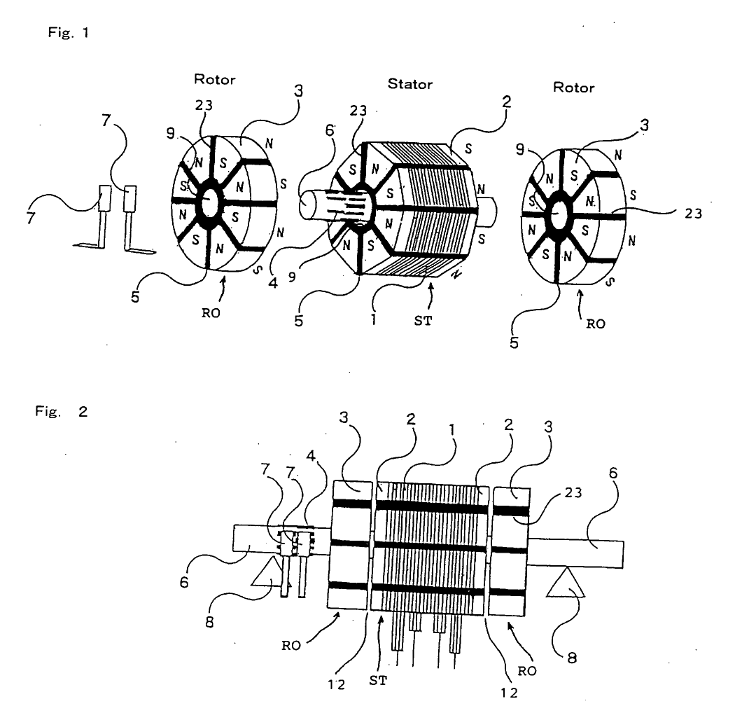

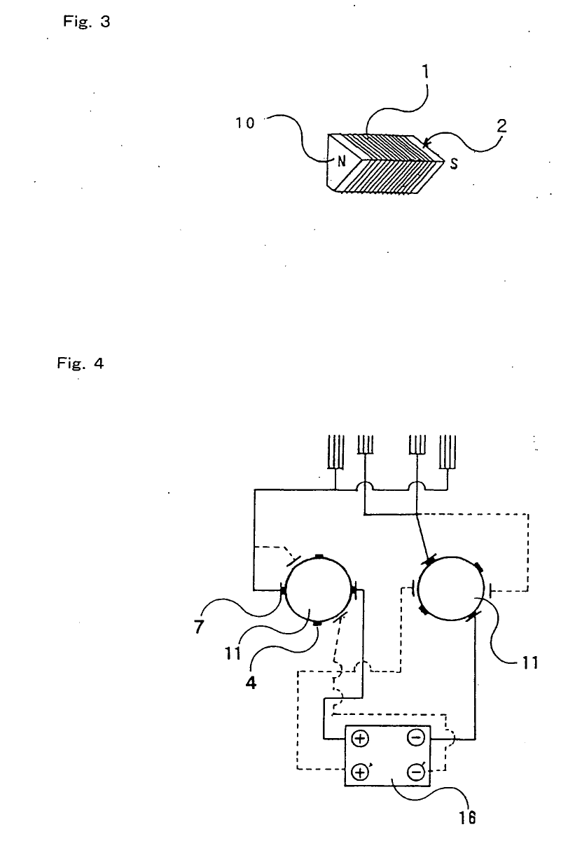

An embodiment according to claim 1 of the present invention will be described with reference to FIGS. 1 to 4. FIG. 1 is an exploded explanatory view showing a rotating apparatus according to the present invention, FIG. 2 is an explanatory view for assembling the same, FIG. 3 is a sketch of an electromagnet constituting a stator, and FIG. 4 is a wiring diagram.

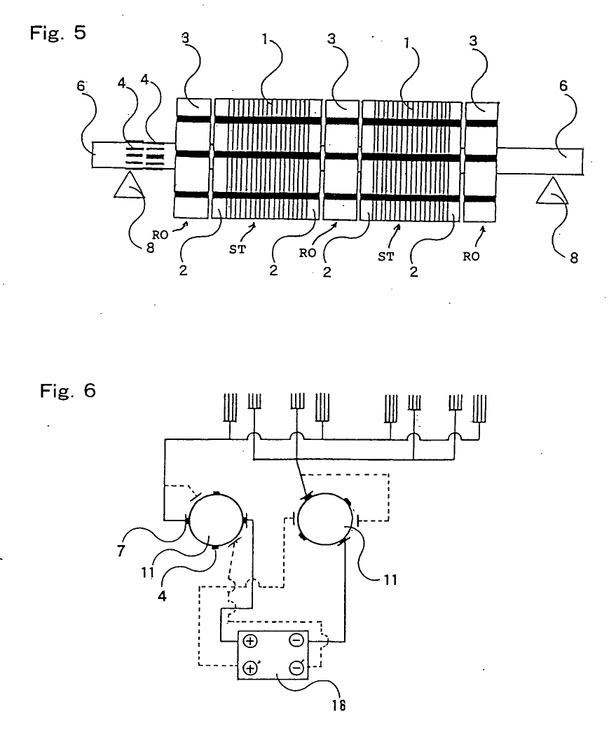

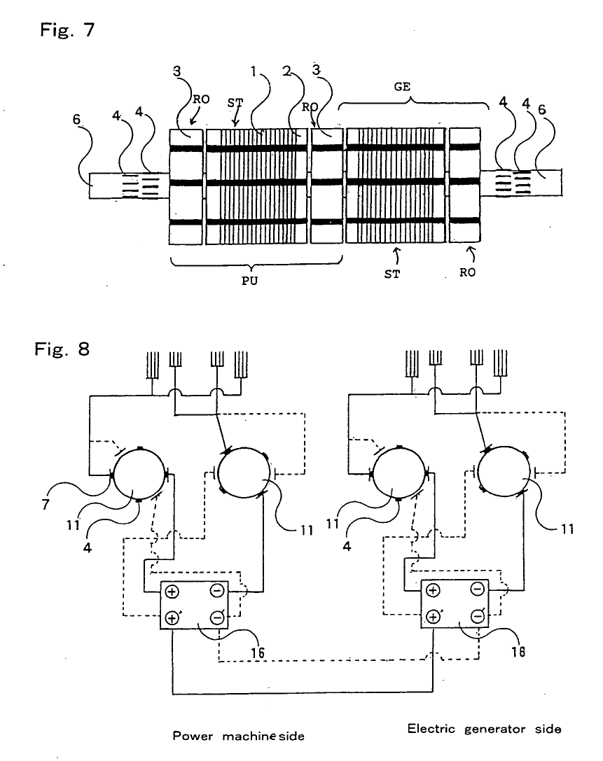

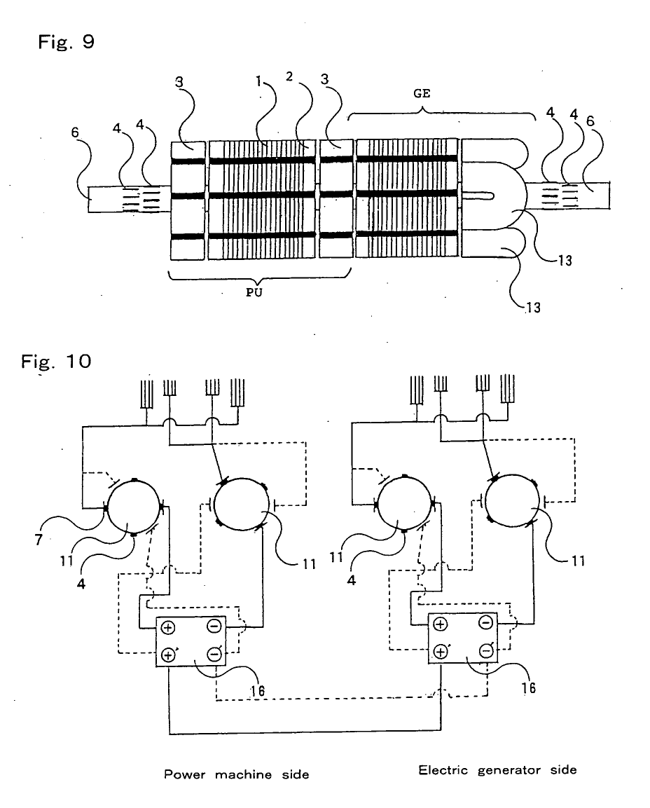

Referring to FIG. 1, there is provided a rotating apparatus with high efficiency which comprises the stator ST in which a plurality of electromagnets 2 (referring to FIG. 3) formed by winding the coil 1 around the core 10 formed of a material by laminating silicon steel plates or the like or formed of ferrite core, permalloy or the like are arranged at almost the same intervals and fixed to the frame body 23, and the rotors RO in which the same number of the permanent magnets 3 as that of the electromagnets 2 of the stator ST are arranged at almost the same intervals as that of the electromagnet 2 of the stator ST on both right and left end surfaces of the stator ST and fixed to the frame body 23, and in which a small gap 12 is provided between the electromagnet surface of the stator ST and the permanent magnet surface of the rotor RO. According to claim 3 of the present invention, plural rotating apparatuses are adjacently provided in column along the driving shaft 6 (referring to FIG. 5).

According to the greatest characteristic referring to an input of an electric power in the present invention, electromagnetism of N→S is generated by one commutator 4 from the left direction of the alternate half number of the electromagnets 2 of the stator ST comprising the plural electromagnets 2 formed by winding the coil, and at the same time, the electromagnet N→S is generated from the right direction of the remaining half number of the electromagnets 2 (referring to FIG. 16). For example, in a case where the eight electromagnets 2 of the stator ST are provided, if they are numbered by No. 1 to No. 8, the No. 1, 3, 5 and 7 generate the electromagnetism N→S from the left side by one commutator 4 and at the same time, the No. 2, 4, 6 and 8 generate electromagnetism N→S from the right side (referring to FIG. 17). In other words, an electric power is input to all of the electromagnets 2 of the stator ST at the same time and all of them generate the electromagnetism to aggressively apply absorption and repulsion to the permanent magnet surface of the adjacent rotor RO. Since the core 10 of the stator ST is formed of a silicon steel plate, permalloy or the like, the previously input electromagnetism is demagnetized in a moment and there is almost no magnetic flux in the core 10. As a result, the above switching is possible and all of the multipolar stators ST act on N→S, S←N, and generate strong rotational driving force. This is a method for switching the electromagnetism of N→S and S←N instantly from both right and left ends of the stator ST and inputting them.

In addition, the positions of both right and left permanent magnet surfaces of the rotor RO of the present invention do not form a counterpart because one permanent magnets 3 of the rotor RO are fixed so as to be slightly back and force. As a result, it easily starts in direction of the rotation on start-up.

According to the present invention, since strong rotation force is output by adding the magnetism of the permanent magnets 3 of the rotor RO to the magnetism of the electromagnets 2 of the stator ST, it is desirable that the magnetic force of the electromagnets 2 of the stator ST and the magnetic force of the permanent magnets 3 of the rotor RO are almost equal to avoid excitation. As a result, it is preferable to adopt the permanent magnet 3 having almost the equal magnetic force as the permanent magnets 3 of the rotors RO opposed at both ends of the stator ST.

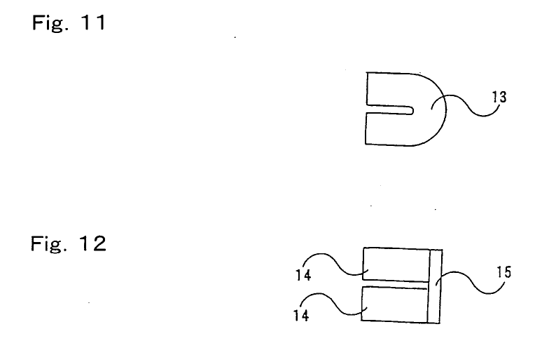

In addition, as shown in claim 5, the U-shaped permanent magnet 3 or the stick permanent magnet 14 to which the metal plate 15 formed of iron, cobalt, nickel or the like on one end surface can be provided on the rotor RO (referring to FIGS. 11 and 12).

Furthermore, as shown in claim 6, if the power machine PU of the rotating apparatus of the present invention, and the electric generator GE are adjacently provided along the driving shaft 6, driving force of power machine PU and electric generation from the electric generator GE are provided at the same time. This is possible because the magnetic force of the permanent magnet is added to the rotating apparatus according to the present invention and output torque is strong. The electric power generated at this time is stored in a storage battery (referring to FIG. 13).

In addition, as shown in claim 7, in the case that the power machine PU of the rotating apparatus of the present invention and the electric generator GE are adjacently provided on one end of the driving shaft 6 of the present invention, the apparatus may be constituted such that the stator 21 of the electric generator GE and the rotor 22 of the electric generator GE move along the driving shaft 6 together in transversal direction to expand the gap 12 with the power machine PU and to expand also the gap 12 between the electromagnet surface of the stator 21 of the electric generator and the permanent magnet surface of the rotor 22 of the electric generator GE near the stator 21 (referring to FIGS. 14 and 15).

The reason of the above constitution is that if the rotating apparatus according to the present invention is employed as a power machine of an automobile, for example, when the automobile is started or climbs a hill, strong rotation force is necessary. In this case, as shown in FIG. 14, by an operation of a driver or a mechanical constitution, the stator 21 and the rotor 22 of the electric generator GE move along the driving shaft 6 in transversal direction to expand the gap 12 with the power machine PU. Furthermore, as shown in FIG. 15, the gap 12 between the electromagnet surface of the stator 21 of the electric generator GE and the permanent magnet surface of the rotor 22 of the electric generator GE which is closed to the electromagnet surface of stator 21 of the electric generator GE is expanded to stop electric generating ability of the electric generator GE, so that a load the electric generator GE applies to the driving shaft 6 of the power machine PU is removed. Meanwhile, when the automobile travels on a stable flat ground, the stator 21 and rotor 22 of the electric generator GE move along the driving shaft 6 in transversal direction as shown in FIG. 14, expanding the gap 12 with the power machine PU and reducing a load of the power machine PU to the driving shaft 6. In addition, while the automobile runs downhill or is parked, the power machine PU and the electric generator GE approach to each other to generate the maximum electrical energy as shown in FIG. 13, which can be stored in the storage battery.

As described above, according to the present invention, although the electromagnet becomes the stator and the permanent magnet becomes the rotor, the configuration can be disposed in reverse such that the electromagnet is rotated at a central part to become the rotor and the permanent magnets are fixed to the both ends to become the stator.

### INDUSTRIAL APPLICABILITY

As described above, according to the present invention, there is provided a rotating apparatus with high efficiency by means of magnetic force in which the permanent magnets of the rotor act on the electromagnetic force occurring from both ends of the stator and absorption force and repulsion force are generated to obtain strong rotational movement. According to the apparatus, as compared with electric power input to the stator from a power source, output torque becomes considerably strong, and high electromotive efficiency is provided. When the electric generator is adjacently provided, the electric power which is simultaneously generated is stored in the storage battery, a part of which can be used again. Therefore, as an example, since strong rotation force can be taken out from the electric power got from the small battery and the stored electric power can be used, an epoch-making power source can be provided in a wide field such as an automobile, a marine vessel, an aircraft, industrial machinery, agricultural and fishery industry implements, generation of electrical energy, or an amusement device.

There is a similar structure in which an electromagnet and a permanent magnet are combined together in a conventional electric motor, but the present invention has a great characteristic in that the stator and rotor are disposed in parallel and the permanent magnet of the rotor acts on the electromagnetism of both right and left end surfaces of the stator, which is essentially different from the conventional motor. When plural apparatuses of the present invention are arranged in column, one is detached among two permanent magnets arranged in parallel at the center and both sides of the permanent magnet can be used, which is different at all from the conventional electric motor.

Since the storage battery or the like is used as a power source and petroleum or the like is not used as a fuel according to the present invention, this is the epoch-making invention which can solve many issues such as environment pollution by automotive exhaust gas, depletion of underground resources, or a global warming issue.

What is claimed is:

1. A rotating apparatus with high efficiency by means of magnetic force, comprising a stator ST in which a plurality of electromagnets 2 composed by winding a coil 1 around a core 10 formed of a strong magnetic material are uniformly arranged at the same intervals, the stator ST having a driving shaft hole 9 at the center in which a driving shaft 6 is freely rotatable and the stator ST being provided such that the driving shaft 6 is inserted in the driving shaft hole 9, and rotors RO in which the same numbers of permanent magnets 3 as that of the electromagnets 2 of the stator ST are arranged at the same intervals as that of the electromagnets 2 of the stator ST on both right and left end surfaces of the stator ST, the rotors RO being fixed to the driving shaft 6 with a small gap 12 with the electromagnet surface of the stator ST.

2. A rotating apparatus with high efficiency by means of magnetic force according to claim 1, wherein the strong magnetic material is selected from a silicon steel plate and permalloy.

3. A rotating apparatus with high efficiency by means of magnetic force, wherein a plurality of apparatuses according to claim 1 are adjacently provided along the driving shaft 6 in column.

4. A rotating apparatus with high efficiency by means of magnetic force according to claim 1, wherein an electric power can be input alternately from the right and left sides of the stator ST through a plurality of commutator and brush circuits 11.

5. A rotating apparatus with high efficiency by means of magnetic force according to claim 1, wherein in the rotor RO, a U-shaped permanent magnet 13 or a stick permanent magnet 14 to which a metal plate 15 selected from iron, cobalt and nickel is attached on one end surface is used.

6. A rotating apparatus with high efficiency by means of magnetic force, wherein an electric generator GE constituted by the same manner as in a power machine PU comprising the apparatus according to claim 1 and formed of a electric circuit opposite to the power machine PU is adjacently provided at one end of the driving shaft 6.

7. A rotating apparatus with high efficiency by means of magnetic force, wherein in the apparatus according to claim 6, a U-shaped permanent magnet 13 or a stick permanent magnet 14 to which a metal plate 15 selected from iron, cobalt and nickel is attached on one end surface is used in the rotor 22 of the electric generator GE.

8. A rotating apparatus with high efficiency by means of magnetic force, wherein in the apparatus according to claim 6, the stator 21 of the electric generator GE and the rotor 22 of the electric generator GE laterally move to expand a gap 12 with the power machine PU and also expand the gap 12 between the stator 21 of the electric generator GE and the rotor 22 of the electric generator GE.
